(19) United States
(12) Patent Application Publication
(10) Pub. No.: US 2017/0099330 A1
(43) Pub. Date: Apr. 6, 2017

(54) CELLULAR STREAMING ENTERTAINMENT SYSTEM

(71) Applicant: Joseph Hobart, Stillwater, OK (US)

(72) Inventor: Joseph Hobart, Stillwater, OK (US)

(21) Appl. No.: 15/041,586

(22) Filed: Feb. 11, 2016

Related U.S. Application Data
(60) Provisional application No. 62/238,053, filed on Oct. 6, 2015.

(51) Int. Cl. H04L 29/06; H04B 1/06

(52) U.S. Cl. CPC H04L 65/4069; H04B 1/06

(57) ABSTRACT

A standalone device for streaming entertainment can take various forms, including, but not limited to, headphones, earbuds, receivers, speakers and the like. Some embodiments may be programmable via a separate interface, such as a smart phone application, web site interface, or computer software interface. In these embodiments, the device may be pre-programmed to receive a signal from one or more streaming entertainment services. During use, the device, using a built-in cellular interface, will contact the streaming service and deliver that content to the user. The device can include a screen and controls to access one or more streaming applications and select streaming programming, which is delivered to the device via a cellular signal. The device can include a cellular chipset and may include a physical or wireless port for linking the device with a secondary device. The secondary device may be useful for programming the device, for example.

### CROSS-REFERENCE TO RELATED APPLICATIONS

This application claims the benefit of priority of U.S. Provisional patent application No. 62/238,053, filed Oct. 6, 2015, the contents of which are herein incorporated by reference.

### BACKGROUND OF THE INVENTION

The present invention relates to entertainment systems and, more particularly, to a cellular streaming entertainment system that does not require a separate cellular phone or smart phone.

Typically, when one desires to receive streaming entertainment, such as streaming audio, they need to have a mobile cellular device, such as a smart phone, with an application installed therewithin for receiving the streaming audio. The smart phone then either plays the streaming entertainment over its speakers or via an external headphone, either wired to the smart phone or receiving a wireless audio signal therefrom.

This can often prove to be inconvenient, as it ties up the user's smart phone. For example, if one wishes to tether their smart phone to external speakers to play music for a party, the phone must remain at that location (or, for Bluetooth® speakers, within a certain distance therefrom). The user must leave their phone, often unattended and it may be difficult to receive calls or text messages on a phone being dedicated to such a purpose.

Additionally, many people enjoy music during exercise, and may use streaming audio services, such as Pandora, iheartradio, Spotify, or the like, to stream audio, via their smart phones, to headphones or earbuds during exercise. Similarly, this requires the user carry their smart phone with them during exercise. This may risk dropping the phone while performing exercises that may jolt the body. Moreover, exercise clothing often does not have a convenient smart phone carrying method and, when carried on the person, may be damaged by the user's sweat, for example.

As can be seen, there is a need for stand-alone device that can receive streaming entertainment and deliver that streaming entertainment to the user without requiring a separate cellular device.

### SUMMARY OF THE INVENTION

In one aspect of the present invention, a stand-alone cellular reception device comprises a cellular chipset configured to receive streaming entertainment from a streaming service; a memory for storing user preferences and settings; a processor for storing an application to access a streaming entertainment service based on the user preferences and settings; and a sound producing means for delivering the streaming entertainment to a user.

These and other features, aspects and advantages of the present invention will become better understood with reference to the following drawings, description and claims.

### BRIEF DESCRIPTION OF THE DRAWINGS

FIG. 1 is a perspective view of a cellular earbud according to an exemplary embodiment of the present invention;

FIG. 2 is a front view of a cellular headphone according to an exemplary embodiment of the present invention;

FIG. 3 is a front view of a cellular wearable unit, such as a cellular watch, according to an exemplary embodiment of the present invention;

FIG. 4 is a front view of a cellular receiver according to an exemplary embodiment of the present invention;

FIG. 5 is a front view of a cellular streaming interface according to an exemplary embodiment of the present invention; and

FIG. 6 is a partially cut-away front view of a standalone cellular speaker according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a standalone device for streaming entertainment. The device of the present invention can take various forms, including, but not limited to, headphones, earbuds, receivers, speakers and the like. Some embodiments may be programmable via a separate interface, such as a smart phone application, web site interface, computer software interface, or the like. In these embodiments, the device may be pre-programmed to receive a signal from one or more streaming entertainment services. During use, the device, using a cellular interface built-in, will contact the streaming service and deliver that content to the user. In other embodiments, the device of the present invention can include a screen and controls to access one or more streaming applications and select streaming programming, which is delivered to the device via a cellular signal.

The device of the present invention can include a cellular chipset and may include a physical or wireless port for linking the device with a secondary device. The secondary device may be useful for programming the device, for example.

As used herein, the term “cellular signal” refers to various mobile communication standards, such as 3G, 4G LTE, GSM, and the like.

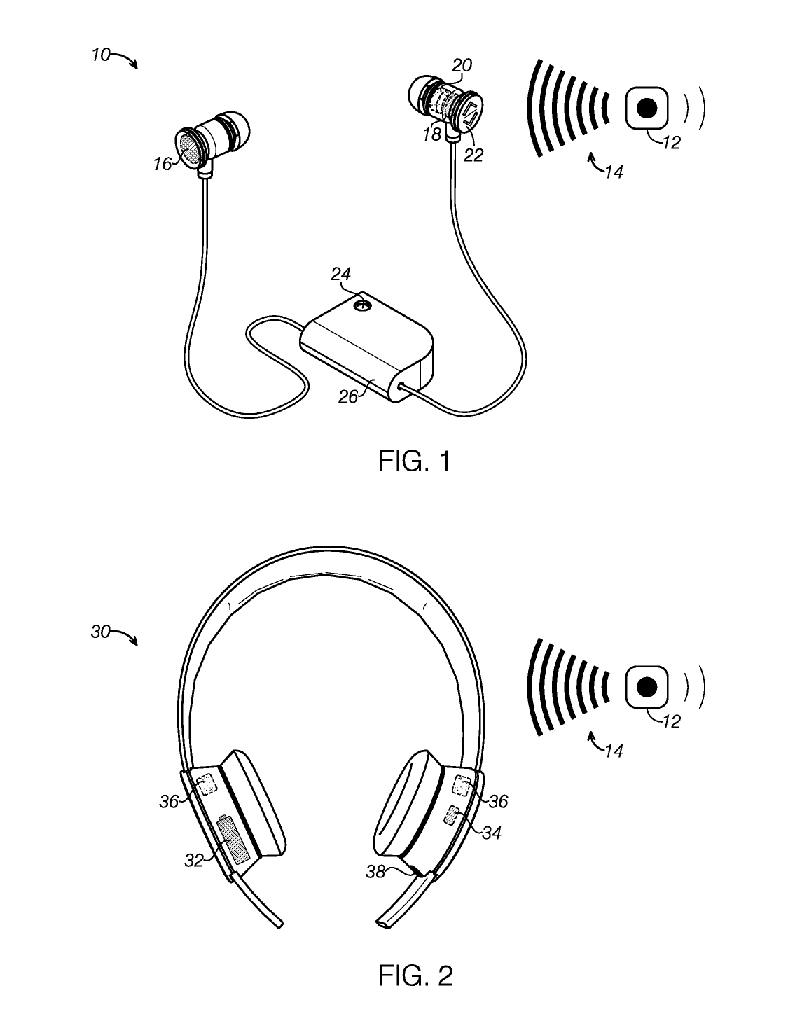

Referring to FIG. 1, in one embodiment, earbuds 10 may be configured to communicate, via a cellular signal 14, to receive audio from one or more audio streaming services 12. The earbuds 10 may include one or more batteries 16, a cellular chipset 18 for sending and receiving cellular signals and memory 20 for storing at least one computer program capable of accessing a streaming entertainment service. While the Figure shows the cellular chipset 18 and the memory 20 in one earbud 10 and the batteries 16 in the other earbud 10, the location of each of the items may be located at various positions within the device as may be understood by one skilled in the art.

The earbuds may further include various controls, indicators (such as LEDs), and the like. At a minimum, the earbuds may include controls 22 for turning on and off, playing and stopping streaming audio, and volume. The earbuds may be configured to receive a wireless signal or may be configured with a port 24 for connecting to a secondary device and for charging the batteries. The secondary port may be used to load software, user preference, streaming service IDs and passwords, and the like, onto the earbuds. Various wireless protocols may be utilized, such as WiFi, Bluetooth®, or the like.

In some embodiments, the earbuds may be equipped with additional features, such as a terrestrial radio tuner 26, a text to talk feature, or the like.

Referring to FIG. 2, in one embodiment, headphones 30 may be configured to communicate, via a cellular signal 14, to receive audio from one or more audio streaming services 12. Like the earbuds 10 described above, the headphones 30 may include one or more batteries 32, a cellular chipset 34 for sending and receiving cellular signals and memory 36 for storing at least one computer program capable of accessing a streaming entertainment service. The headphones 30 may further include various controls 36, indicators (such as LEDs), and the like. At a minimum, the headphones may include controls for turning on and off, playing and stopping streaming audio, and volume. The headphones may be configured to receive a wireless signal or may be configured with a port 38 for connecting to a secondary device and for charging the batteries or for wired use as conventional headphones. The secondary port may be used to load software, user preference, streaming service IDs and passwords, and the like, onto the headphones. Various wireless protocols may be utilized, such as WiFi, Bluetooth®, or the like.

In some embodiments, the headphones may be equipped with additional features, such as a terrestrial radio tuner, a text to talk feature, or the like. Like the earbuds 10, the location of the various components (such as the controls 36, the battery 32, the memory 36 and the cellular chipset 34) can vary from that shown in the Figure, provided that the features are provided within the structure of the headphones 30.

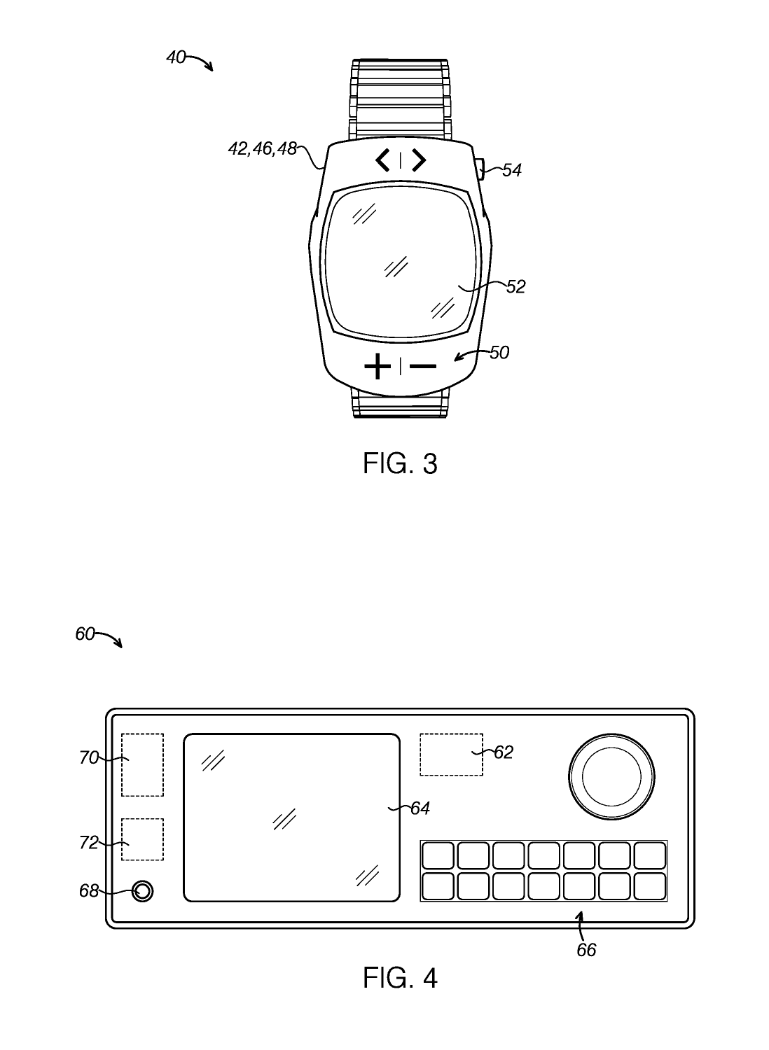

Referring now to FIG. 3, in one embodiment, a wearable unit, such as a watch-like device 40, may be configured to communicate, via a cellular signal (not shown), to receive audio from one or more audio streaming services (not shown). Like the earbuds 10 and headphones 30 described above, the watch-like device 40 may include one or more batteries 42, a cellular chipset 44 for sending and receiving cellular signals and memory 48 for storing at least one computer program capable of accessing a streaming entertainment service. The watch-like device 40 may further include various controls 50, indicators (such as LEDs), touchscreens 52, and the like. At a minimum, the watch-like device 40 may include controls for turning on and off, playing and stopping streaming audio, and volume. The watch-like device 40 may be configured to receive a wireless signal or may be configured with a port 54 for connecting to a secondary device and for charging the batteries. The secondary port may be used to load software, user preference, streaming service IDs and passwords, and the like, onto the watch-like device. Various wireless protocols may be utilized, such as WiFi, Bluetooth®, or the like. The watch-like device 40 may be attached, for example, to a band 56 for application to a user's wrist.

Referring to FIG. 4, a receiver 60 can be a fixed device with a cellular chipset 62 built in to receive cellular signals. The receiver 60 may include a display 64 or touchscreen, various controls 66, similar to those described above, and may include an audio output 68, such as a 3.5 mm jack, speakers, RCA plugs, or the like.

Like the portable devices discussed above (earbuds 10, headphones 30, watch-like device 40), the receiver 60 can receive streaming entertainment from a streaming service and deliver that entertainment to the user. Like the devices discussed above, the receiver 60 may include memory 70 for storing programs and a processing unit 72 for running programs that can access various streaming services.

The receiver 60 can include various other functions, such as a terrestrial radio tuner, equalizer controls and other like features as may be present on conventional receivers.

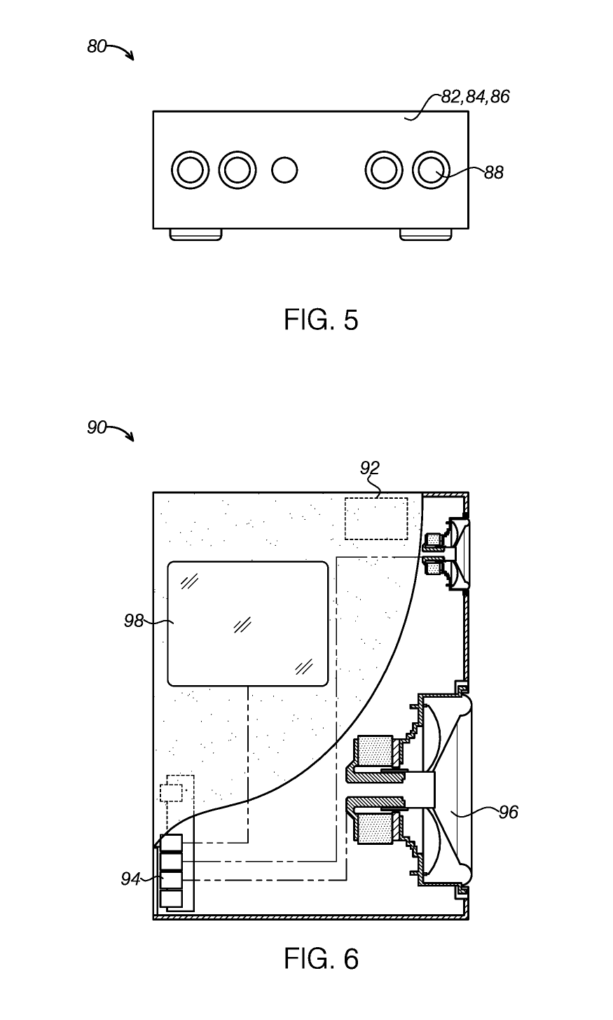

Referring now to FIG. 5, a “black box” type streaming device 80 may be similar to the receiver 60 described above, but may be stripped down in size and features, similar to the earbuds 10 described above. The black box device 80 may include a cellular chipset 82, memory 84 and a processor 86 for executing applications, and a method to communicate with other devices, such as Bluetooth®, WiFi and the like. The black box device 80 may include one or more audio outputs 88 to send the streaming audio to speakers, headphones or the like. The black box type device 80 may be similar to the above devices in that a streaming audio service may send user-selected streaming audio to the device for enjoyment by the user.

Referring to FIG. 6, a speaker device 90 can be similar to the above described devices, in that a cellular chipset 92 may be used to receive a cellular signal. An application may reside in the speaker device 90 that can access streaming audio services. The speaker device 90 may include connections 94 for power and the like. The speaker device 90 may play the audio through one or more speakers 96 and/or may feed the audio through wireless or wired signals to other sound producing devices. A control panel 98 may provide access to various controls for the speaker device 90. Such controls may be similar to those described above for the various embodiments.

Regardless of design, the device of the present invention may also be capable of coordinating with another music playing device such that, a user can seamlessly change from using their music playing device (such as their smartphone) to the device of the present invention and pick up the content where the prior music playing device left off. For example, if a user is listening to content on Pandora® on their smartphone in their car driving to the park, the user can change to one of the stand-alone, integrated devices of the present invention, such as headphones 30 or earbuds 10, and use this item to listen to continue the content stream (where the smartphone left off) while walking in the park, freeing up their phone for other functions or not requiring the user to take their phone with them.

It should be understood that other features are contemplated within the scope of the present invention. For example, the portable devices may include other features such as tracking, navigation, and the like. The devices may have sufficient memory to load additional applications into the device to provide additional features. The devices may include an operating system, such as an Android® operating system to permit a wide variety of additional applications to add to the functionality of the device.

It should be understood, of course, that the foregoing relates to exemplary embodiments of the invention and that modifications may be made without departing from the spirit and scope of the invention as set forth in the following claims.

1. A stand-alone cellular reception device comprising:
a cellular chipset configured to receive streaming entertainment from a streaming service, wherein the cellular chipset is used solely for receiving streaming entertainment;
a memory for storing user preferences and settings;
a processor for storing an application to access a streaming entertainment service based on the user preferences and settings; and
a sound producing means for delivering the streaming entertainment to a user.

2. (canceled)

3. The stand-alone cellular reception device of claim 1, further comprising a battery for powering the cellular reception device.

4. The stand-alone cellular reception device of claim 1, further comprising controls.

5. The stand-alone cellular reception device of claim 4, wherein the controls include at least volume controls for adjusting a volume of the streaming entertainment delivered to the user.

6. The stand-alone cellular reception device of claim 1, further comprising a terrestrial radio receiver disposed therein.

7. The stand-alone cellular reception device of claim 1, further comprising a communication protocol built into the device to permit programming thereof

8. (canceled)

9. The stand-alone cellular reception device of claim 1, further comprising at least one output jack.

10. The stand-alone cellular reception device of claim 1, wherein the device is in the form of earbuds.

11. The stand-alone cellular reception device of claim 1, wherein the device is in the form of headphones.

12. The stand-alone cellular reception device of claim 1, wherein the device is in the form of a watch-like device.

13. The stand-alone cellular reception device of claim 1, wherein the device is in the form of a receiver.

14. The stand-alone cellular reception device of claim 1, wherein the device is in the form of an audio speaker.
